(19) United States
(12) Patent Application Publication
(10) Pub. No.: US 2026/0155659 A1
(43) Pub. Date: Jun. 4, 2026

(54) ADAPTIVE MANAGEMENT OF MULTI-PACK BATTERY SYSTEM

(71) Applicant: Caterpillar Inc., Peoria, IL (US)

(72) Inventors: Avinash Dongare, Karnataka (IN); Deepa Kesavan, Karnataka (IN)

(21) Appl. No.: 18/967,495

(22) Filed: Dec. 3, 2024

(51) Int. Cl. H02J 7/00; H02J 7/14

(52) U.S. Cl. CPC H02J 7/50; H02J 7/1423; H02J 7/82; H02J 7/84; H02J 7/94; H02J 7/977

(57) ABSTRACT

The present disclosure is directed to systems and methods for adaptive management of a multi-pack battery system. The system includes a battery array including a first battery pack and a second battery pack; and a battery array controller configured to: for each of multiple time points during an energy exchange cycle, evaluate current limits of the first and second battery packs; and assess a system performance metric based on the current limits of the first and second battery packs. The system is configured to continuously evaluate the system performance and dynamically adjust the connection status of the individual battery packs to improve the system performance.

### TECHNICAL FIELD

The present disclosure relates to technology configured to improve battery system functionality. More specifically, the present disclosure relates to adaptive management of charge and discharge of multiple battery packs of a battery system.

### BACKGROUND

Work machines, such as mining trucks, loaders, dozers, compaction machines, or other construction or mining equipment, have been traditionally powered by internal combustion engines. These engines have generally provided power to propulsion system components configured to move the work machine along a travel path, and typically also provide power to an electrical system associated with the work machine. However, the source of power of work machines as well as the use of the electrical systems have evolved. Whereas in the past, combustion engines have been the primary source of motive and electrical power, work machines are increasingly using battery systems which may include multiple battery modules as the primary source of energy, either augmenting an internal combustion system in the case of a hybrid work machine, or supplanting the internal combustion system altogether in the case of an electric, non-hybrid (EV) work machine.

Such battery systems discharge during use and can be charged, or recharged, between or during uses. Variability in the charge or discharge levels of the battery modules within the battery system may occur during discharging and recharging of the systems. For example, during charging cycles, certain modules may charge faster and achieve a significantly higher charge level than other modules within the battery system. Similarly, during use or discharging, certain modules may discharge faster and achieve a significantly lower charge level than other modules within the battery system. This variability can negatively impact the performance of the battery system.

For example, Chinese Patent Application Publication No. 115230531A discloses a method for managing a battery system with multiple battery packs connected in parallel. The method addresses the issue of varying states of charge (SOC) among different battery packs within the system. In this approach, when a battery pack reaches full charge, it is disconnected from the charging process. The system then uses the SOC of the remaining, still-charging battery packs to represent the overall system SOC. This technique is designed to provide a more accurate indication of the system's true charging status, preventing premature termination of the charging process that may otherwise occur if the system relies on the SOC of the earliest fully charged battery pack.

### SUMMARY

In one aspect of the present disclosure, a system includes a battery array that includes a first battery pack and a second battery pack, each of the first battery pack and the second battery pack including at least one battery cell; and a battery array controller configured to: for each of multiple time points during an energy exchange cycle, evaluate current limits of the first and second battery packs; and assess a system performance metric based on the current limits of the first and second battery packs. At a first time point of the multiple time points during the energy exchange cycle, the battery array controller is configured to: determine that the current limit of the first battery pack is lower than the current limit of the second battery pack; determine that the system performance metric calibrated with respect to the first battery pack satisfies a criterion; command the first battery pack to disconnect from the energy exchange cycle; and allow the second battery pack to continue the energy exchange cycle based on a current limit higher than the current limit of the first battery pack.

In another aspect of the present disclosure, a work machine includes an electric motor and a battery system powering the electric motor. The battery system includes a battery array comprising a plurality of battery packs and a battery array controller. Each of the plurality of battery packs includes at least one battery cell. The battery array controller is configured to: for each of multiple time points during an energy exchange cycle, evaluate current limits of the plurality of battery packs; and assess a system performance metric of the battery system based at least in part on the current limits of the plurality of battery packs. At a first time point of the multiple time points during the energy exchange cycle, the battery array controller is configured to: determine that the current limit of at least one battery pack is lower than a current limit of each of one or more remaining battery packs of the battery array; determine that the system performance metric calibrated with respect to the at least one battery pack satisfies a criterion; command the at least one battery pack to disconnect from the energy exchange cycle; and allow the one or more remaining battery packs to continue the energy exchange cycle with each of the one or more remaining battery packs operating at a current limit higher than the current limit of the at least one battery pack.

In a still further aspect of the present disclosure, a method includes for each of multiple time points during an energy exchange cycle on a battery system that comprises a battery array, evaluating, by a battery array controller, current limits of a first battery pack and a second battery pack of the battery array, each of the first battery pack and the second battery pack comprising at least one battery cell; and assessing, by the battery array controller, a system performance metric of the battery system based on the current limits of the first and second battery packs; and at a first time point of the multiple time points during the energy exchange cycle: determining, by the battery array controller, that the current limit of the first battery pack is lower than the current limit of the second battery pack; determining, by the battery array controller, that the system performance metric calibrated with respect to the first battery pack satisfies a criterion; commanding, by the battery array controller, the first battery pack to disconnect from the energy exchange cycle; and allowing, by the battery array controller, the second battery pack to continue the energy exchange cycle based on a current limit higher than the current limit of the first battery pack.

### BRIEF DESCRIPTION OF DRAWINGS

FIG. 1 is a schematic illustration of an example work machine that travels over a surface, in accordance with embodiments of the present disclosure.

FIG. 2 is schematic illustration of a battery system, in accordance with embodiments of the present disclosure.

FIG. 3 is a schematic illustration of the battery array of the battery system of FIG. 2, in accordance with embodiments of the present disclosure.

FIG. 4 is a schematic illustration of a battery array controller of the battery system of FIG. 2, in accordance with embodiments of the present disclosure.

FIG. 5 is a schematic diagram illustrating components in a computing device in accordance with embodiments of the present disclosure.

FIG. 6 is a flowchart illustrating a method of managing an energy exchange cycle of the battery system, in accordance with embodiments of the present disclosure.

### DETAILED DESCRIPTION

Systems and technologies described below are directed to adaptive management of a battery system. Wherever possible, the same reference numbers will be used throughout the drawings to refer to the same or like parts.

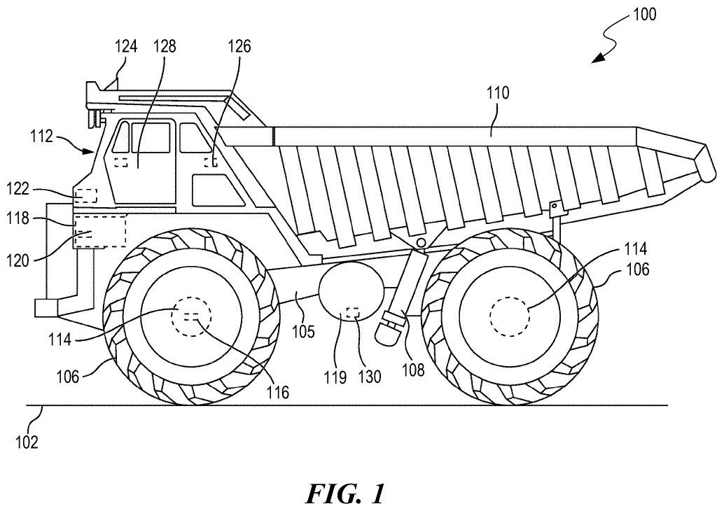

FIG. 1 is a schematic illustration of an example work machine 100 that travels over a surface 102, in accordance with examples of the disclosure. The work machine 100, although depicted as a mining truck type of machine, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. In some examples, the work machine can be a hybrid system, an electric vehicle (no internal combustion engine), or use internal combustion as the primary source of energy. The presently disclosed subject matter is not limited to any particular platform of use and may be implemented across various types of vehicles, installations (e.g., non-vehicle uses), and the like. The work machine 100 of FIG. 1 is merely for purposes of illustration.

As shown in FIG. 1, the work machine 100 includes a frame 105 and wheels 106. The wheels 106 are mechanically coupled to a drive train (not shown) to propel the work machine 100. When the wheels 106 of the work machine 100 are caused to rotate, the work machine 100 traverses the surface 102. Although illustrated in FIG. 1 as having a hub with a rubber tire, in other examples, the wheels 106 may instead be in the form of drums, chain drives, combinations thereof, or the like. The frame 105 of the work machine 100 is constructed from any suitable materials, such as iron, steel, aluminum, other metals, ceramics, plastics, the combination thereof, or the like. The frame 105 is of a unibody construction in some cases, and in other cases, is constructed by joining two or more separate body pieces. Parts of the frame 105 are joined by any suitable variety of mechanisms, including, for example, welding, bolts, screws, other fasteners, epoxy, combinations thereof, or the like.

The work machine 100 may include a hydraulic system 108 that moves a dump box 110 or other moveable elements configured to move, lift, carry, and/or dump materials. The dump box 110 is used, for example, to pick up and carry dirt or mined ore from one location on the surface 102 to another location of the surface 102. The dump box 110 is actuated by the hydraulic system 108, or any other suitable mechanical system. In some cases, the hydraulic system 108 is powered by an electric motor (not shown), such as by powering hydraulic pump(s) (not shown) of the hydraulic system 108. It should be noted that in other types of machines (e.g., machines other than a mining truck) the hydraulic system 108 may be in a different configuration than the one shown herein, may be used to operate elements other than a dump box 110, and/or may be omitted.

With continued reference to FIG. 1, the work machine 100 also includes an operator station 112. The operator station 112 is configured to seat an operator (not shown) therein. The operator seated in the operator station 112 interacts with various control interfaces and/or actuators within the operator station 112 to control movement of various components of the work machine 100 and/or the overall movement of the work machine 100 itself. Thus, control interfaces and/or actuators within the operator station 112 allow the control of the propulsion of the work machine 100 by controlling operation of one or more motors 114 that are electric motors, the motors 114 being controlled by a motor controller 116 and powered by a battery system 118. The battery system 118 includes one or more battery modules, each module having one or more cells that, when electrically connected, provide a battery. The motor controller 116 may be controlled according to operator inputs received at the operator station 112. A battery system controller 120 monitors and controls various aspects of the battery system 118, such as monitoring a temperature or SOC of the battery system 118 or the battery modules, or management of the charge levels of the battery system 118 or the battery modules.

The motors 114 may be of any suitable type, such as induction motors, permanent magnet motors, switched reluctance (SR) motors, combinations thereof, or the like. The motors 114 are of any suitable voltage, current, and/or power rating. The motors 114 when operating together are configured to propel the work machine 100 as needed for tasks that are to be performed by the work machine 100. For example, the motors 114 may be rated for a range of about 500 volts to about 3000 volts. The motor controller 116 includes control electronics configured to control the operation of the motors 114. In some cases, each motor 114 may be controlled by its own motor controller 116. In other cases, all the motors of the work machine 100 may be controlled by a single motor controller 116. The motor controller 116 may further include one or more inverters or other circuitry to control the energizing of magnetic flux generating elements (e.g., coils) of the motors 114. The motors 114 are mechanically coupled to a variety of drive train components, such as a drive shaft and/or axles or directly to the wheels 106 to rotate the wheels 106 and propel the work machine 100.

The drivetrain includes any variety of other components including a differential, connector(s), constant velocity (CV) joints, etc. Although not shown here, there may be one or more motors 114 that are not used for propulsion of the work machine 100, but rather to operate pumps and/or other auxiliary components, such as to operate the hydraulic systems 108. According to examples of the disclosure, the power to energize the motors 114 is received from the battery system 118. It should be noted that, in some cases, the battery system 118 may provide power for operating the motors 114 and/or other power consuming components (e.g., controllers, cooling systems, displays, actuators, sensors, etc.) of the work machine 100. As noted above, the presently disclosed subject matter is not limited solely to the use of battery power, as other forms of energy may be used in conjunction with the power provided by the battery system 118, including internal combustion engines or fuel cells.

The battery system 118 may be of any suitable type and capacity. For example, the battery module can be a lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. The battery system 118 may be organized as a collection of electrochemical cells arranged to provide the voltage, current, and/or power requirements of the motors 114. In some cases, the energy capacity of the battery system 118 relative to the energy available from a full fuel tank 119 may be in the range of about 0.2 to about 1.5. In other cases, the energy capacity of the battery system 118 relative to the energy available from a full fuel tank 119 may be in the range of about 0.5 to about 1. In still other cases, the energy capacity of the battery system 118 relative to the energy available from a full fuel tank 119 may be in the range of about 0.7 to about 0.9. It should be understood that the aforementioned ratios are examples, and the disclosure contemplates the battery system 118 energy capacity to the fuel tank 119 energy capacity ratios in ranges outside of the aforementioned ranges.

The work machine 100 includes an electronic control module (ECM) 122 that controls various aspects of the work machine 100. The ECM 122 is configured to receive battery status (e.g., state-of-charge (SOC) or other charge related metrics) from the battery system controller 120, fuel level from the fuel tank controller 130, operator signal(s), such as an accelerator signal, based at least in part on the operator's interactions with one or more control interfaces and/or actuators of the work machine 100. In other cases, the ECM 122 may receive control signals from a remote-control system by wireless signals received via an antenna 124. The ECM 122 uses the operator signal(s), regardless of whether they are received from an operator in the operator station 112 or from a remote controller, to generate command signals to control various components of the work machine 100. For example, the ECM 122 may control the motors 114 via the motor controller 116, the hydraulic system 108, and/or steering of the work machine 100 via a steering controller 126. It should be understood that the ECM 122 may control any variety of other subsystems of the work machine 100 that are not explicitly discussed here to provide the work machine 100 with the operational capability discussed herein.

The ECM 122, according to examples of this disclosure, may be configured to provide an indication of remaining energy to operate the work machine 100 on an energy gauge 128. The energy gauge 128, according to examples of the disclosure, may be configured to display the amount of energy available to operate the work machine 100 based at least in part on the amount of charge remaining in the battery system 118. In some cases, the energy gauge 128 may provide an indication of an estimated amount of time the work machine 100 can be operated and/or an estimated amount of range the work machine 100 has remaining. These estimates may be generated based on the amount of charge remaining in the battery system 118, the recent usage of energy by the work machine 100, and/or an estimate of the energy expended per unit time (e.g., power requirement) of a task in which the work machine 100 is engaged. The energy gauge 128 may be configured to display, to an operator seated in the operator station 112, the amount of energy, time, and/or range remaining for operating the work machine 100. Additionally or alternatively, the energy gauge 128 and/or the ECM 122 may be configured to indicate, such as wirelessly via the antenna 124, the amount of energy, time, and/or range remaining for operating the work machine 100 to a remote operating system.

The ECM 122 includes single or multiple microprocessors, field programmable gate arrays (FPGAs), digital signal processors (DSPs), and/or other components configured to control the work machine 100. Numerous commercially available microprocessors can be configured to perform the functions of the ECM 122. Various known circuits are operably connected to and/or otherwise associated with the ECM 122 and/or the other circuitry of the work machine 100. Such circuits and/or circuit components include power supply circuitry, inverter circuitry, signal-conditioning circuitry, actuator driver circuitry, etc. The present disclosure, in any manner, is not restricted to the type of ECM 122 or the positioning depicted of the ECM 122 and/or the other components relative to the work machine 100. The ECM 122 is configured to control the use of energy from the battery system 118 in a manner that enhances the range of the work machine 100.

The work machine 100 further includes any number of other components within the operator station 112 and/or at one or more other locations on the frame 105. These components include, for example, one or more of a location sensor (e.g., global positioning system (GPS)), an air conditioning system, a heating system, communications systems (e.g., radio, Wi-Fi connections), collision avoidance systems, sensors, cameras, etc. These systems are powered by any suitable mechanism, such as by using a direct current (DC) power supply powered by the battery system 118.

Rechargeable battery systems undergo cycles of discharge during use and recharge between or during operational periods. However, these systems often experience variability in charge and discharge levels among their constituent battery modules. During charging cycles, some modules may charge more rapidly, achieving significantly higher charge levels compared to others within the same battery system. Conversely, during operational use or discharging phases, certain modules may deplete their charge more quickly, resulting in substantially lower charge levels relative to other modules in the system. This non-uniform behavior across modules can lead to suboptimal performance of the overall battery system, potentially compromising its efficiency, longevity, and reliability.

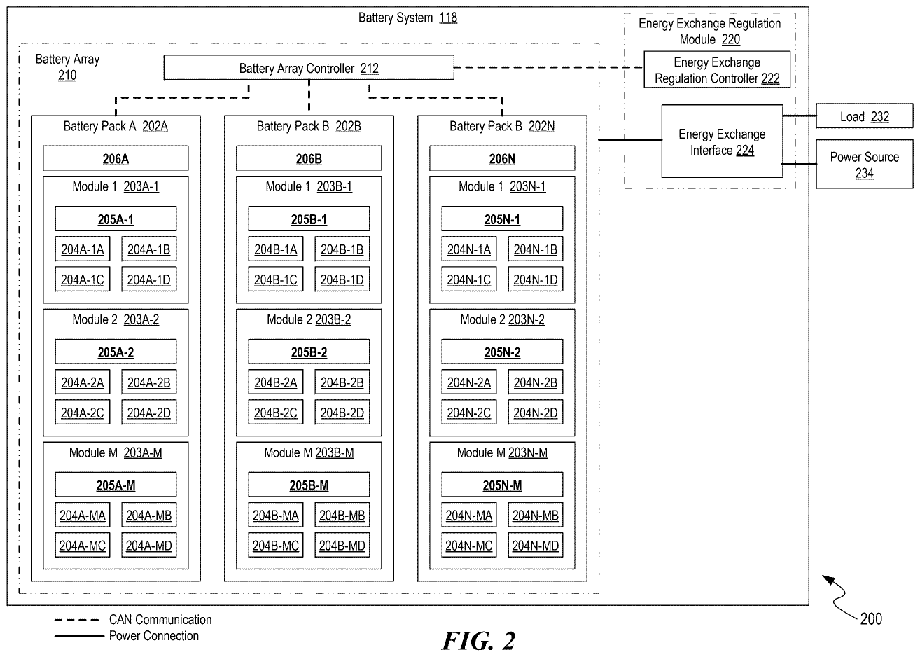

FIG. 2 is a schematic illustration of a power system 200, in accordance with examples of the present disclosure. The power system 200 may include a battery system 118 designed for high-power applications, capable of both energy storage and delivery. For example, the power system 200 may be used to power a load 232, such as systems of a work machine (e.g., the motors 114 as illustrated in FIG. 1). The battery system 118 includes a battery array 210 and an energy exchange regulation module 220.

The battery system 118 may be of any suitable type and capacity. For example, the battery system 118 may provide one or more types of batteries such as, e.g., lithium ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like.

The battery system 118 includes two or more battery packs 202 (identified individually as battery pack 202A, battery pack 202B, . . . and battery pack 202N in FIG. 2). Each battery pack 202 includes one or more battery modules 203 (identified individually as 203A-1, 203A-2, . . . , 203A-M for battery pack 202A as illustrated in FIG. 2). Each battery module 203 includes one or more battery cells 204 (identified individually as 204A-1A, 204A-1B, 204A-1C, 204A-1D for Module 1 203A-1 of battery pack 202A as illustrated in FIG. 2, etc.). This naming convention is consistent across all battery packs 202, though labels are omitted for packs 202B and 202N to maintain diagram clarity.

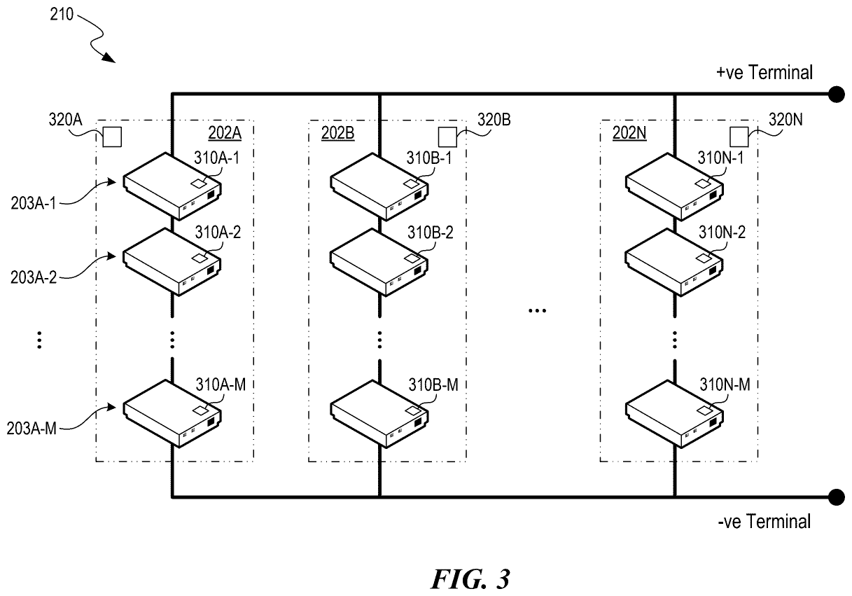

FIG. 3 is a schematic illustration of the battery array 210 of the battery system 118 of FIG. 2, in accordance with embodiments of the present disclosure. FIG. 3 depicts the modular and scalable architecture of the battery array 210. FIG. 3 shows the parallel configuration of multiple battery packs 202 (identified individually as battery packs 202A, 202B, . . . and 202N). This parallel arrangement of the battery packs 202 allows for increased power capacity and system expansion.

Each battery pack 202 includes a series of battery modules 203. For example, for battery pack 202A, these modules are labeled as 203A-1, 203A-2, and extend to 203A-M. This naming convention is consistent across all battery packs 202, though labels are omitted for packs 202B and 202N to maintain diagram clarity. M and N, both positive integers, may be the same or different.

The battery modules 203 within each pack 202 are connected in series. This series connection allows for voltage accumulation within each pack 202. Conversely, the battery packs 202 themselves are connected in parallel. This parallel configuration enables the battery system 118 to increase its overall current capacity while maintaining a consistent voltage across the battery array 210. Alternative configurations may also be implemented. For example, a battery pack 202 may include battery modules 203 connected in parallel, thereby increasing the current capacity at the pack level. As another example, a battery pack 202 may employ a combination of series and parallel connections among its battery modules 203, enabling simultaneous optimization of both voltage and current capabilities at the pack level.

While some battery modules 203 may have the cells 204 arranged in a series or parallel configuration, other battery modules 203 may have a combination of both, called a series/parallel configuration. Additionally or alternatively, while some battery packs 202 may have the modules 203 arranged in a series as illustrated, other battery packs 202 may have the modules 203 arranged in parallel, or a combination of both. In various examples, as illustrated in FIGS. 2 and 3, the battery packs 202, the battery modules 203, and the one or more cells 204 within the battery module 203 can be electrically coupled in various configurations. In the exemplary arrangement shown, battery modules 202A-202N are electrically connected in parallel. This modular configuration allows for flexibility in achieving desired system characteristics, such as specific amperage outputs, voltage levels, or power capacities, tailored to meet the needs of external systems, exemplified by the load 232.

For example, the battery pack 202A can be configured to nominally output 50.4 volts. By combining the battery pack 202A with additional packs (202B-202N), the battery system 118 can be configured to supply power to a range of voltage nodes. This scalable architecture enables the battery system 118 to accommodate diverse power needs, including, e.g., 48-volt, 100-volt, 350-400-volt, and 700-750-volt nodes, as well as other voltage and/or current specifications as needed. It should be noted that the above numbers are examples and that the individual battery packs 202 can be configured to store an amount of amp-hours, discharge an electrical current, and receive an additional electrical current that is defined based at least on an application that the battery system 118 is intended for. Accordingly, the battery system 118 and the battery packs 202 can be configured as a scalable power source for various external systems, such as the load 232, accommodating a wide range of voltage and current needs.

In some embodiments, each battery pack 202 includes a sensor module 320 (identified individually as sensor modules 320A, 320B, . . . , 320N). Each sensor module 320 may include one or more sensors or sensing circuits. For example, the sensor module 320 may include a pack-level temperature sensor to monitor the overall temperature of the battery pack, a voltage sensor to measure the pack's total voltage, and a current sensor to monitor the pack's charge and discharge currents. Additionally, the sensor module 320 may include sensors for detecting environmental conditions such as humidity or vibration that could affect the pack's performance or safety.

Additionally or alternatively, each battery module 203 includes a sensor module 310 (identified individually as sensor modules 310A-1, 310A-2, . . . , 310A-M in modules 203A-1, 203A-2, . . . , 203A-M for battery pack 202A). This naming convention is consistent across all battery packs 202, though labels are omitted for packs 202B and 202N to maintain diagram clarity. Each sensor module 310 may include one or more sensors or sensing circuits. For example, the sensor module 310 may incorporate individual cell voltage sensors to monitor the voltage of each cell within the module, a module-level temperature sensor to detect any localized heating, and a current sensor to measure the module's charge and discharge currents. The sensor module 310 may also include sensors for detecting cell swelling or gas emission, which are critical indicators of cell health and safety.

The information flow from these sensor modules is designed to ensure comprehensive monitoring and rapid response to any changes in the battery system's condition. The sensor module 320 at the pack level may provide information directly to the pack controller 206. This allows the pack controller to have immediate access to pack-level data for quick decision-making and safety management.

The sensor modules 310 at the module level may communicate their data to the respective module controllers 205. The module controllers 205 then process this granular data, optionally performing initial calculations or data aggregation, before passing relevant information up to the pack controller 206. This hierarchical data flow allows for efficient data management and enables each level of control to respond appropriately to conditions within its domain.

In some cases, for certain parameters or in systems with simpler control hierarchies, the sensor modules 310 may be configured to provide information directly to the pack controller 206 in addition to or instead of routing through the module controller 205. This direct communication path can allow for rapid response to safety-critical events, such as sudden temperature spikes or voltage anomalies.

This multi-level sensing and data communication structure ensures that the battery management system has access to detailed, real-time information about the state of each component of the battery system, from individual cells up to the entire pack. This comprehensive monitoring capability is essential for optimizing performance, ensuring safety, and maximizing the lifespan of the battery system.

Referring again to FIG. 2, the battery array 210 includes a hierarchical control structure. The battery array 210 includes a battery array controller 212 that oversees and manages the array of battery packs 202. Each battery pack 202 (individually identified as 202A through 202N) is equipped with a dedicated pack controller 206 (correspondingly identified as 206A through 206N). These pack controllers 206 monitor and control various parameters specific to their respective battery packs 202, based on data collected from the modules 203 and cells 204 contained within. The pack controllers 206 transmit pertinent information about their respective packs to the battery array controller 212. This data flow enables the array controller 212, in conjunction with the energy exchange regulation module 220 (described in greater detail below), to effectively regulate the energy exchange cycle—whether charging or discharging—of the battery packs 202.

In some embodiments, the control hierarchy extends further, with each battery module 203 featuring its own module controller 205 (identified individually as module controllers 205A-1 through 205A-N for modules 1 through N of pack 202A, 205B-1 through 205B-N for modules 1 through N of pack 202B, and so on up to 205N-1 through 205N-N for modules 1 through N of pack 202N). Each module controller 205 can monitor and control various parameters related to the battery cells 204 within its specific module. In some embodiments, the battery modules 203 in a battery pack 202 may be divided into a plurality of groups, with each group including multiple battery modules 203 and the battery modules 203 within a group sharing a module controller 205.

The module controllers 205 may communicate with the pack controller 206 of their respective battery pack 202. In some embodiments, a module controller 205 monitors parameters of its cells 204, such as charge levels, voltage, and temperature. Moreover, the module controller 205 can be endowed with advanced functionalities, including the ability to perform load balancing or charge balancing among the plurality of cells 204 within each battery module 203. This granular level of control ensures optimal performance and longevity of each cell, contributing to the overall efficiency and reliability of the entire battery system 118.

The battery array controller 212 is configured to dynamically manage the connection status and load distribution of multiple battery packs 202 during an energy exchange cycle. This management is achieved through coordinated operations with the battery pack controllers 206 and, in some implementations, the battery module controllers 205. For example, the battery array controller 212 may command a battery pack controller 206 to disconnect its corresponding battery pack 202 from an energy exchange cycle or to reconnect a previously disconnected battery pack 202. These connection status adjustments are made based on real-time assessments of system performance, individual pack conditions, and overall power or energy demands. As another example, the battery array controller 212, in conjunction with the battery pack controllers 206 and/or the battery module controllers 205, orchestrates the power input or output across multiple online battery packs 202. This coordination may allow improved or optimal utilization of available battery capacity while maintaining safe operating conditions for each battery pack 202 and battery module 203. In some embodiments, the multi-level control architecture (array controller 212, pack controllers 206, and module controllers 205) allows for redundant decision-making capabilities. If one level of control experiences a fault, the other levels can potentially compensate to maintain system operation, albeit potentially at a reduced capacity or efficiency.

This hierarchical, modular architecture, encompassing both the physical components (battery cells, modules, and packs) and the control system, allows for system scalability. Additional battery cells, modules, or packs can be seamlessly integrated into the system, following the established connection patterns of existing components. This design not only facilitates system expansion but also enhances various aspects of the battery system's lifecycle. It enables more efficient manufacturing processes, simplifies maintenance and repair procedures, optimizes transportation logistics, and streamlines on-site setup and installation. Furthermore, this modular approach provides flexibility in system configuration, allowing for customization to meet specific energy storage needs across diverse applications.

For example, the battery array controller 212 may coordinate with a battery pack controller 206 to dynamically adjust the connection status of the corresponding battery pack 202 during an energy exchange cycle, including disconnecting the battery pack 202 from the energy exchange cycle, or reconnecting the disconnected battery pack 202 for the energy exchange cycle. As another example, the battery array controller 212, the respective battery pack controllers 206, the respective battery module controllers 205 may, alone or in combination, coordinate the power input or output across multiple battery packs 202 online. Merely by way of example, for a total system current limit of 300 A, when three battery packs 202 with identical capacities are online, the battery array controller 212 and the respective battery pack controllers 206 may, alone or in combination, coordinate to distribute the current limit equally across the three online battery packs 202.

The system performance during an energy exchange cycle may be assessed with reference to a system performance metric. The energy exchange cycle may be a charge cycle or a discharge cycle. The system performance metric may include one or more parameters such as total system current capacity, power input/output capability, energy input/output capacity, thermal management effectiveness, or the like, or a combination thereof. The system performance metric may guide the battery system 118 in maintaining or adjusting system configuration. For example, during a discharge cycle, the metric may be used to assess whether the current system configuration can meet power output needs. Based on this assessment, the system 118 may implement configuration changes (e.g., disconnecting or reconnecting one or more battery packs) to improve performance under current operating conditions.

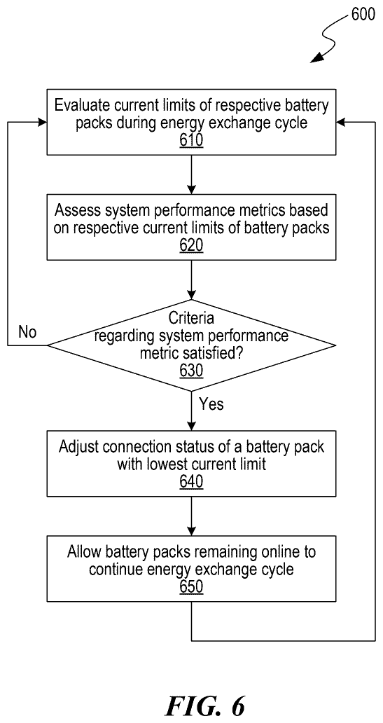

During a charge cycle, the system performance metric may be expressed as a system current limit of the battery array 210. The system current limit at a time point may be determined based on the pack current limits and the number of online battery packs participating in the charge cycle at that time point. The current limit of a battery pack 202 is referred to as a pack current limit for brevity. For safety and other considerations, the individual battery packs 202 of the battery array 210 may operate at the lowest pack current limit among the online battery packs at the time point. This operational limit may be maintained over a time period, such as the interval between consecutive system performance assessments as illustrated in blocks 610-630 of FIG. 6. The system current limit at a time point during the charge cycle may be calculated by multiplying the lowest pack current limit of the online battery packs by the number of these online battery packs. This system current limit indicates the power input capacity of the battery system 118. The energy input capacity, which may also be referred to as energy gain, may be derived from the power input capacity over a defined time period, such as the interval between consecutive system performance assessments.

During a discharge cycle, the system performance metric may similarly be expressed as a system current limit of the battery array 210. This system current limit indicates the power output capacity of the battery system 118 and reflects the battery array 210's ability to deliver power to connected loads under current operating conditions. The system current limit during discharge may be determined using the same approach as during charging, based on the number of online battery packs and their respective current limits.

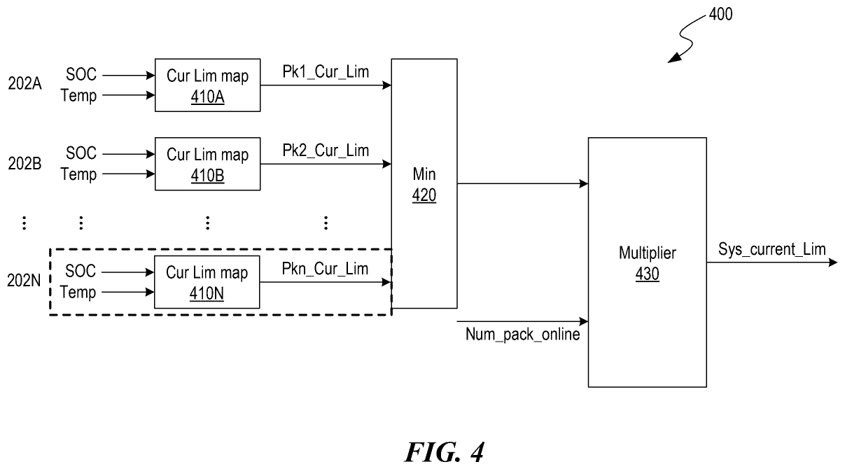

FIG. 4 is a schematic illustration of the battery array controller of the battery system of FIG. 2, in accordance with embodiments of the present disclosure. The battery array controller 212 implements a control logic 400 configured to improve or optimize an energy exchange (e.g., charge or discharge) process of multiple battery packs. As illustrated, the control logic 400 manages current limits across several battery packs 202 (202A, 202B, . . . , 202N) connected in parallel.

The control logics 400 independently monitors each battery pack 202. The control logics 400 obtains the pack current limits of the respective battery packs 202, and determine a system current limit for provision to the energy exchange regulation module 220. The system current limit of the battery system 118 during an energy exchange cycle may be limited by the minimum pack current limit among the battery packs 202 online. The connection status of a battery pack 202 may be adjusted to improve the overall system performance.

The control logics 400 may estimate the pack current limits based on operational parameters of the battery packs 202. Alternatively, the battery packs 202, e.g., the pack controllers 206 of the battery packs 202, may estimate the respective pack current limits, and provide the pack current limits to the battery array controller 212.

A battery pack's current limit may be determined based on operational parameters and models. For example, a current limit map 410 (identified individually as 410A, 410B, . . . , 410N) serves as a model for this calculation. This current limit map 410 correlates various battery states to safe operating current limits. The relevant parameters may include state of charge (SOC) and temperature, and optionally one or more other factors including state of health (SOH), internal resistance, voltage, current, or a combination thereof. These parameters may be measured or calculated at various levels of the battery system hierarchy—at the cell level, module level, or pack level. As another example, a trained machine learning model may be employed, instead of or in addition to the current limit map, potentially considering an expanded set of parameters to determine the current limit accurately or dynamically. Such a model may process multiple input parameters simultaneously to calculate appropriate current limits. The machine learning model may incorporate additional parameters beyond those used in current limit maps, and may adapt to evolving patterns in battery behavior. The model may also account for complex interactions between different operational parameters, potentially enabling more precise current limit calculations based on the battery system's actual operating conditions.

In some embodiments, the SOC of a battery module 203 is determined based on measurements of operational parameters of the battery module 203 including, e.g., voltage and current. Additional operational parameters including, e.g., temperature may influence these measurements and the overall battery behavior. SOC determination may be approached in several ways. For example, the battery module controller 205 calculates the SOC for its respective module using methods such as coulomb counting, voltage-based estimation, or a combination of these. The module controller 205 then communicates this calculated SOC to the battery pack controller 206. As another example, the battery module controllers 205 may send raw measured data (e.g., voltage, current, and temperature) of the respective battery modules 203 to the battery pack controller 206; the battery pack controller 206 then calculates the SOC for each module 203 and, subsequently, for the entire pack 202. As a further example, data of individual cells 204 are communicated directly to the pack controller 206, which then performs SOC calculations for each cell 204, module 203, and the entire pack 202.

In some embodiments, temperature data is obtained from the sensor modules 310 within the battery modules 203. Depending on the system architecture, this temperature data may be accessed by the module controllers 205 and then communicated to the pack controller 206, or read directly by the pack controller 206. The granularity of temperature measurements can vary; some systems may use a single temperature reading per module 203 using the sensor modules 320, while others may have multiple sensors per module 203 (e.g., 310) for more detailed thermal monitoring. The pack controller 206 may use this temperature data not only for SOC calculations but also for thermal management and safety monitoring.

The determination of the pack current limit of a battery pack 202 can follow several approaches. For example, the pack controller 206 uses the pack-level SOC and temperature, derived from module-level data, in conjunction with a current limit map 410 to determine the overall pack current limit. The pack SOC may be calculated based on an average of the module SOCs. The pack temperature may be determined by taking the maximum temperature among all modules 203 of the battery pack 202, an average temperature, or a statistical measure depending on the thermal management needs of the system 118.

As another example, the battery pack controller 206 or the battery module controllers 205 may calculate individual module-level current limits based on the SOC and temperature of the respective modules 203, and then determine a pack current limit based on these module current limits. The current limit of a battery module 203 is referred to as a module current limit for brevity. An exemplary approach is to set the pack current limit equal to the lowest module current limit multiplied by the number (or count) of the battery modules 203 within the battery pack 202. Other approaches may also be employed while maintaining safety, such as using a weighted sum of the module current limits, adjusting limits based on the thermal capacity of the cooling system, or employing a more dynamic approach that considers the real-time state of each module and the overall pack. In some embodiments, a trained machine learning model may be used to predict optimal module or pack current limits based on historical performance data and/or a wider range of input parameters.

The pack current limits are then fed into a comparator 420, denoted as “Min” in FIG. 4. This comparator 420 identifies the lowest pack current limit among all the battery packs 202. The control logic 400 then employs a multiplier 430 to determine a system current limit by assessing the overall system performance.

The multiplier 430 may determine a system performance metric to guide determination as to the connection status of the battery packs 202. For example, with respect to a battery pack at issue, the multiplier 430 determines a calibrated system performance metrics, indicating the effect of the battery pack at issue on the system performance. The calibrated system performance metrics of an energy exchange cycle may include a first system performance parameter with the battery pack 202 at issue remaining connected with other battery packs of the battery array 210 and a second system performance parameter with the battery pack 202 at issue disconnected from the energy exchange cycle with other battery packs of the battery array 210 remaining connected for the energy exchange cycle. In some embodiments, the system performance parameter may be in terms of the system current limit. For example, each of the first and second system performance parameters is determined by the minimum pack current limit among the connected battery packs and the number of the number (or count) of the connected battery packs.

The following example is provided for illustration purposes only and not intended to be limiting. As illustrated in Table 1, the battery array 210 of the battery system 118 includes four battery packs 1 through 4, denoted as pk_1 through pk_4, respectively. During an energy exchange cycle, the pack current limits for battery packs 1-4 are 111 amperes, 110 amperes, 100 amperes, and 60 amperes, respectively. To ensure safety, the energy exchange cycle proceeds so that the current limit for each of the online battery packs pk_1 through pk_4 is limited by the minimum pack current limit among these online battery packs. Among the online battery packs pk_1 through pk_4, pk_4 has the minimum pack current limit, which is 60 amperes. With respect to the battery pack pk_4 at issue, there may be two connection configurations (or referred to as system configurations). In a first connection configuration, pk_4 remains connected, and therefore all four battery packs, pk_1 through pk_4, are all online for the energy exchange cycle. In a second connection configuration, pk_4 disconnects from the energy exchange cycle, and therefore three battery packs, pk_1 through pk_3, remain online for the energy exchange cycle. See FIG. 4 in which 202N, corresponding to pk_4 in this example, is disconnected as indicated by the dashed box.

A first system performance parameter corresponding to the first connection configuration is calculated by multiplying the minimum pack current limit, which is 60 amperes, by the total number of battery packs online, which is 4, resulting in 240 amperes.

TABLE 1

| | Pack | | | Number | System |
|---|---|---|---|---|---|
| | current | | Min of | of battery | current |
| | limit (A) | SOC | all (A) | packs online | limit (A) |
| Pk_1 | 111 | 0.48 | 60 | 4 | 240 |
| Pk_2 | 110 | 0.5 | | | |
| Pk_3 | 100 | 0.58 | | | |
| Pk_4 | 60 | 0.7 | | | |

In the second connection configuration, among the three battery packs remaining online, pk_1 through pk_3, pk_3 has the minimum pack current limit, which is 100 amperes. A second system performance parameter is calculated by multiplying the minimum pack current limit, which is 100 amperes, by the total number of battery packs online, which is 3, resulting in 300 amperes. See Table 2.

TABLE 2

| | Pack | | | Number | System |
|---|---|---|---|---|---|
| | current | | Min of | of battery | current |
| | limit (A) | SOC | all (A) | packs online | limit (A) |
| Pk_1 | 111 | 0.48 | 100 | 3 | 300 |
| Pk_2 | 110 | 0.5 | | | |
| Pk_3 | 100 | 0.58 | | | |
| (Pk_4) | (60) | (0.7) | | | |

Based on the calibrated system performance metrics including the first and system performance parameters corresponding to the first and second connection configurations, respectively, the control logic 400 determines that taking pack pk_4 with the lowest current limit offline improves the overall system performance, increasing the system performance parameter in terms of the system current limit from 240 to 300 amperes. The control logic 400 determines that the system performance improves by disconnecting pk_4 from the energy exchange cycle and an optimized system current limit is 300 amperes. In some embodiments, the control logic 400 communicates an optimized system current limit (300 amperes in this example) to the hardware controlling the charge or discharge cycle.

In some embodiments, the control logic 400 may assess additional parameters as part of the system performance assessment. For example, the control logic 400 checks a further calibrated system performance metrics with respect to battery pack pk_3. The multiplier 430 determines a first system performance parameter corresponding to a first connection configuration and a second system performance parameter corresponding to a second connection confirmation. In the first connection configuration, pk_3 remains connected, and therefore three battery packs, pk_1 through pk_3, are online for the energy exchange cycle, among which pk_3 has the lowest current limit; accordingly, the first system performance parameter is calculated by multiplying the minimum pack current limit, which is 100 amperes, by the total number of battery packs online, which is 3, resulting in 300 amperes. In a second connection configuration, pk_3 disconnects from the energy exchange; between the two battery packs pk_1 and pk_2 that remain online, the lower current limit is 111 amperes; accordingly, the second system performance parameter is calculated by multiplying the minimum pack current limit, which is 110 amperes, by the total number of battery packs online, which is 2, resulting in 220 amperes, lower than the corresponding first system performance parameter. The control logic 400 determines that the system performance decreases by further disconnecting pk_3 from the energy exchange cycle and an optimized system current limit is 300 amperes.

As another example, the control logic 400 incorporates state of charge (SOC) comparison between battery packs as part of its system performance assessment. As an illustration, the energy exchange cycle being a charge cycle, the control logic 400 may check whether the SOC of the battery pack(s) at issue (0.7 for pk_4 in the example described with reference to Tables 1 and 2) is higher than the SOC of each of one or more battery packs that remain online as suggested by the calibrated system performance metrics with respect to the battery pack(s) at issue (0.48, 0.5, and 0.58 for pk_1 through pk_3, respectively, in the example described with reference to Tables 1 and 2). Accordingly, the criteria to satisfy before the control logic 400 commands one or more battery packs at issue to disconnect from the charge cycle include (1) that the system performance metrics calibrated with respect to the one or more battery packs at issue indicates improved performance with the battery pack(s) at issue disconnected from the energy exchange cycle and (2) that the SOC of the battery pack(s) at issue (being considered for disconnection) is higher than the SOC of each of at least one or all battery pack(s) that would remain online. As another illustration, the energy exchange cycle being a discharge cycle, the criteria to satisfy before the control logic 400 commands one or more battery packs at issue to disconnect may include (1) that the system performance metrics calibrated with respect to the one or more battery packs at issue indicates improved performance with the battery pack(s) at issue disconnected from the energy exchange cycle and (2) that the SOC of the battery pack(s) at issue (being considered for disconnection) is lower than the SOC of each of at least one or all battery pack(s) that would remain online. This dual-criteria approach may help ensure that disconnecting a battery pack not only improves system performance but also maintains appropriate energy distribution across the battery array.

Returning to FIG. 2, the battery array controller 212 (e.g., implementing the control logic 400) may perform continuous system performance assessment throughout the energy exchange cycle. As an energy exchange cycle proceeds, the current limits of both connected (online) and disconnected (offline) battery packs may dynamically change. These changes can result from factors including, e.g., the change in the SOC of the respective online battery pack(s), the change in the temperature of both the online and offline battery pack(s), or the like, or a combination thereof. For example, during the charge cycle with pk_4 disconnected, several dynamic changes may occur simultaneously, including that the pack current limits of the online packs (pk_1 through pk_3) may decrease as their SOCs increase and that the pack current limit of the disconnected pack (pk_4) may increase as its temperature decreases. Through these repeated system performance assessments, the battery array controller 212 can identify appropriate time points for system reconfiguration. For example, the battery array controller 212 may determine a specific time point when reconnecting pk_4 to the energy exchange cycle may enhance system performance, based on updated current limits of all battery packs.

The battery array controller 212 implements this adaptive management approach through two primary mechanisms. First, it collaborates with the pack controllers 206 to dynamically adjust the connection status of individual battery packs 202. Second, it continuously calculates and updates the system current limit based on real-time operational states of the battery packs 202.

The battery array controller 212 provides control parameters to the energy exchange regulation module 220 to govern the energy exchange operations of the battery array 210. As illustrated in FIG. 4, the control logic 400 determines and transmits the system current limit to the energy exchange regulation module 220. The energy exchange regulation module 220 then utilizes this system current limit to regulate the actual current flow during both charging and discharging operations.

The energy exchange regulation module 220 includes an energy exchange regulation controller 222 and an energy exchange interface 224. The battery array controller 212 communicates with the energy exchange regulation controller 222, providing it with information relating to operation of the battery array including, e.g., system current limit as described further below. Based on this information, the energy exchange regulation controller 222 controls the energy exchange interface 224, which in turn regulates the current flow to and from the battery packs 202.

The energy exchange regulation controller 222 manages the energy exchange within the battery system 118 by controlling the energy exchange interface 224, which may be implemented as an inverter, converter, or similar power electronics device. The controller 222 receives operation information of the battery array 210, e.g., the system current limit, from the battery array controller 212 and uses this information to regulate the operation of battery array 210 by controlling the operation of the energy exchange interface 224. For example, the energy exchange regulation controller 222 regulates the interface 224 to maintain the charging current within the system current limit while ensuring proper current distribution among the battery packs. This current distribution may be implemented through various control architectures. In one implementation, the interface 224 may manage current distribution independently. Alternatively, the distribution may be coordinated among multiple system components, including the interface 224, battery array controller 212, and battery pack controllers 206.

For example, the energy exchange regulation controller 222 employs pulse-width modulation (PWM) techniques to adjust the switching patterns of the power electronic components within the energy exchange interface 224. During discharge operations, the energy exchange regulation controller 222 modulates the energy exchange interface 224 to convert the DC power from the battery array into the appropriate form (AC or DC) needed by the load 232, regulating the current flow to match the system current limits while meeting the load demands. Conversely, during charging operations, the energy exchange regulation controller 222 manages the power conversion process, adapting the incoming power (whether AC or DC) into DC power suitable for battery charging, again adhering to the specified system current limits. During the energy exchange cycle (e.g., a charge cycle, a discharge cycle), the controller 222 continuously monitors key parameters such as voltage levels, current flow, and power quality, making real-time adjustments to the energy exchange interface 224's operation to maintain optimal performance and efficiency of the battery system 118.

In some embodiments, the energy exchange regulation controller 222 uses digital signals, e.g., in the form of PWM, to control the switching elements (such as an insulated gate bipolar transistor (IGBT) or a metal-oxide-semiconductor field-effect transistor (MOSFET)) within the energy exchange interface 224. By varying the pulse widths, the energy exchange regulation controller 222 can accurately regulate the power flow, adjusting factors such as voltage levels, current flow, and frequency of the output power.

There are additional examples of the use of digital signals by the energy exchange regulation controller 222. For example, the energy exchange regulation controller 222 communicates, using digital signals, with other system components (e.g., the battery array controller 212), exchanging data and status updates. As another example, the energy exchange regulation controller 222 may communicate, using digital signals, with user interface devices, such as local display panels or remote monitoring software. These interfaces allow operators to view system status, adjust settings, and receive alerts, all facilitated by the digital communication capabilities of the controller 222. As a further example, the controller 222 may communicate with smart grid components or renewable energy systems. For instance, it might exchange data with a solar inverter controller to coordinate power flow in a hybrid solar-plus-storage system, or with a smart meter to participate in demand response programs.

In some embodiments, the energy exchange regulation controller 222 uses analog signals for real-time monitoring and fine control adjustments. For example, it receives analog signals from various sensors within the battery system 118, including voltage sensors measuring battery and output voltages, current sensors monitoring power flow, and temperature sensors ensuring safe operating conditions. These analog inputs provide the energy exchange regulation controller 222 with instantaneous feedback about the system's state, allowing for rapid adjustments to maintain desired or optimal performance of the energy exchange interface 224.

In some embodiments, the energy exchange regulation controller 222 is implemented through a combination of hardware and software components. The hardware may include a microcontroller or digital signal processor (DSP), an analog-to-digital converter (ADC) for sensor inputs, a digital-to-analog converter (DAC) for control outputs, and various communication interfaces. In some embodiments, the software architecture is built on a real-time operating system (RTOS) and includes components for power management, control loops, state machines for operational modes, fault detection and protection routines, communication protocols, and diagnostic functionalities.

The energy exchange regulation controller 222 may implement algorithms to handle various operational scenarios, including sudden load changes, fault conditions, and transitions between charging and discharging modes. By controlling the energy exchange interface 224, the energy exchange regulation controller 222 may ensure that the power flow between the battery array 210 and the external power system (load 232, power source 234) remains within safe operating limits while improving or maximizing system efficiency and responsiveness to changing energy demands or supply conditions.

In some embodiments, the energy exchange interface 224 is bidirectional, allowing for both charging and discharging operations. The energy exchange interface 224 may be implemented using various power electronic devices suited to specific operational needs and power characteristics of the connected power sources or loads. In some embodiments, the energy exchange interface 224 includes an inverter, a converter, a transformer, etc. The energy exchange interface 224 may include an inverter for interfacing the battery system 118 with an AC power source/load (e.g., load 232, power source 234 as illustrated in FIG. 2). The inverter allows for the conversion between the DC power of the battery system 118 and the AC power of the external grid or AC loads, ensuring energy exchange in both directions.

Additionally or alternatively, the energy exchange interface 224 may include a DC-DC converters for a DC power source/load, a matrix converter for direct AC-AC conversion, or a solid-state transformer for high-frequency power conversion and isolation. In some embodiments, the energy exchange regulation module 220 may include multiple unidirectional inverters or converters, dedicating separate units for charging and discharging processes. In some embodiments, the energy exchange regulation module 220 may include a combination of components, enabling the battery system 118 to seamlessly interface with both AC and DC power sources and loads. This dual-mode capability may broaden the system's applicability across diverse energy environments.

The battery system 118 interfaces with both a load 232 and a power source 234. The power source 234 is connected to the battery array via the energy exchange interface 224 or a similar component, ensuring that the charging of the battery array 210 proceeds in a controlled manner. This configuration allows the battery system 118 to operate in various scenarios, such as delivering power to an electrical load (e.g., the load 232), charging from the grid or renewable energy sources, a mobile equipment charger, etc.

For example, during a charge cycle, for example, when three battery packs pk_1 through pk_3 are connected and pk_4 disconnected, the battery array controller 212 may communicate a system current limit, 300 amperes in the example, to the energy exchange controller 222. Based on this limit, the energy exchange regulation controller 222 may regulate the interface 224 to maintain the charging current within this limit. The total charging current, 300 amperes in this example, may be distributed among the online battery packs, such as allocating 100 amperes to each of the three battery packs pk_1 through pk_3.

In some embodiments, the distribution of charging current among the battery packs may be managed by the interface 224, the battery array controller 212, a coordinated control between the battery array controller 212 and the respective pack controllers 206, etc. The battery array controller 212, alone or in combination with the battery pack controller 206, may cause pk_4 to be disconnected and not receive the charging power.

While not explicitly shown in the schematic, the battery system 118 may include thermal management capabilities. The battery system 118 may include temperature sensors at either the pack level, or the module level, or both, to provide data to their respective controllers, allowing for real-time monitoring and management of thermal conditions. This data is used to optimize battery performance and ensure safe operation across various environmental conditions.

In some embodiments, the battery system 118 includes safety systems. These may include emergency disconnects, overcurrent protection devices, and isolation mechanisms at various levels of the system hierarchy. The hierarchical control structure, with controllers at the array, pack, and module levels, facilitates the implementation of multi-layered safety protocols.

The data flow within the battery system 118 may be facilitated by a controller area network (CAN) communication network. This network carries a wide range of data, including current limits, temperature readings, state of charge information, fault indicators, and control commands. The battery array controller 212 aggregates and processes this data to make system-level decisions, such as determining the overall system current limit, which is then communicated to the energy exchange regulation controller 222.

The battery system 118 includes a modular, scalable architecture with sophisticated control and power conversion capabilities. It's suitable for a wide range of high-power applications requiring reliable and efficient energy storage and delivery, as well as the ability to integrate with various power sources for bidirectional energy flow.

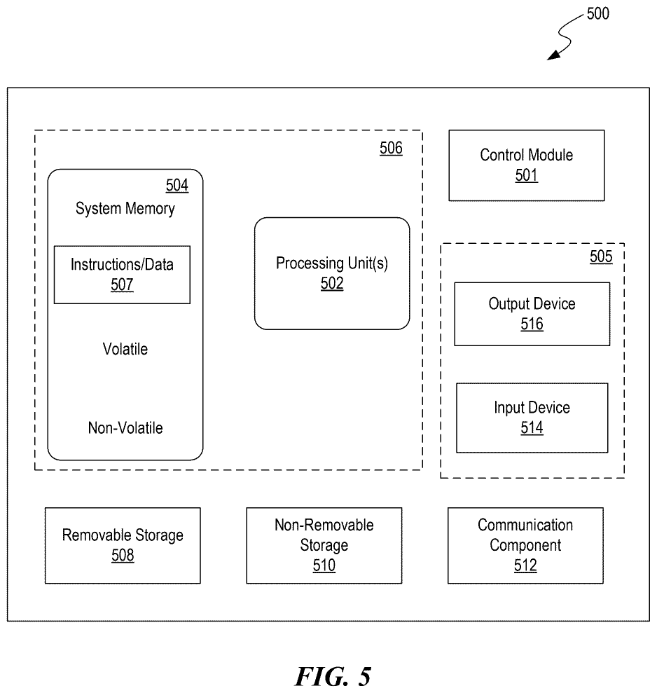

FIG. 5 is a schematic diagram illustrating components in a computing device 500, in accordance with embodiments of the present technology. The computing device 500 can be used to implement methods (e.g., FIG. 6) discussed herein. The computing device 500 can be used to perform the processes/operations discussed in FIGS. 1-4. Note the computing device 500 is only an example of a suitable computing device and is not intended to suggest any limitation as to the scope of use or functionality. Other well-known computing systems, environments, and/or configurations that may be suitable for use include, but are not limited to, personal computers (PCs), server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, the computing device 500 includes at least one processing unit 502 and a memory 504. Depending on the exact configuration and the type of computing device, the memory 504 may be volatile (such as a random-access memory or RAM), non-volatile (such as a read-only memory or ROM, a flash memory, etc.), or some combination of the two. This basic configuration is illustrated in FIG. 5 by dashed line 506. Further, the computing device 500 may also include storage devices (a removable storage 508 and/or a non-removable storage 510) including magnetic or optical disks or tape. Similarly, the computing device 500 can have an input device 514 such as keyboard, mouse, pen, voice input, etc. and/or an output device 516 such as a display, speakers, printer, etc. Also included in the computing device 500 can be one or more communication components 512, such as components for connecting via a local area network (LAN), a wide area network (WAN), cellular telecommunication (e.g. 3G, 4G, 5G, etc.), point to point, any other suitable interface, etc.

The computing device 500 can include a control module 501 configured to implement methods for operating the battery system 118 based on one or more sets of parameters corresponding to components of the battery system 118 in various situations and scenarios. For example, the computing device 500 can be configured to implement a control module 501 (e.g., corresponding to the battery array controller 212, the control logic 400, the energy exchange regulation controller 222) for regulating energy change cycles discussed herein. In some embodiments, the control module 501 can be in form of tangibly stored instructions, software, firmware, as well as a tangible device. In some embodiments, the output device 516 and the input device 514 can be implemented as the integrated user interface 505. The integrated user interface 505 is configured to visually present information associated with inputs and outputs of the machines.

The computing device 500 includes at least some form of computer readable media. The computer readable media can be any available media that can be accessed by the processing unit 502. By way of example, the computer readable media can include computer storage media and communication media. The computer storage media can include volatile and nonvolatile, removable and non-removable media (e.g., removable storage 508 and non-removable storage 510) implemented in any method or technology for storage of information such as computer readable instructions, data structures, program modules or other data. The computer storage media can include, a random access memory (RAM), a read-only memory (ROM), an electrically erasable programmable read-only memory (EEPROM), a flash memory or other suitable memory, a compact disc read-only memory (CD-ROM), digital versatile disks (DVD) or other optical storage, magnetic cassettes, magnetic tape, magnetic disk storage or other magnetic storage devices, or any other tangible medium which can be used to store the desired information.

The computing device 500 includes communication media or component 512, including non-transitory computer readable instructions 507, data structures, program modules, or other data. The computer readable instructions 507 can be transported in a modulated data signal such as a carrier wave or other transport mechanism and includes any information delivery media. The term “modulated data signal” means a signal that has one or more of its characteristics set or changed in such a manner as to encode information in the signal. By way of example, the communication media can include wired media such as a wired network or direct-wired connection, and wireless media such as acoustic, radio frequency (RF), infrared and other wireless media. Combinations of any of the above should also be included within the scope of the computer readable media.

The computing device 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

FIG. 6 is a flowchart illustrating a method of managing an energy exchange cycle of the battery system, in accordance with embodiments of the present disclosure. The method 600 may be implemented by the battery array controller 212 for operation on the battery system 118 described above with reference to FIGS. 2-4.

At block 610, the process 600 includes evaluating current limits of respective battery packs (or referred to as pack current limits) during the energy exchange cycle. The energy exchange cycle may be a charge cycle or a discharge cycle. These current limits may be determined based on various operational parameters of each battery pack, such as the state of charge and temperature. For example, the current limit of a battery pack is estimated based on the SOC and the temperature of the battery pack, and a current limit map. As another example, the current limit of a battery pack is estimated by inputting the SOC and the temperature, or one or more additional operational parameters, of the battery pack into a trained machine learning model. In some embodiments, for a battery pack that includes multiple battery modules, the pack current limit may be determined directly at the pack level based on operational parameters of the pack, e.g., SOC and temperature of the pack; the operational parameters of the pack may be determined based on operational parameters of the modules of the pack. In some embodiments, for a battery pack that includes multiple battery modules, the pack current limit may be determined based on module current limits of the battery modules of the pack. For example, the pack current limit relates to the lowest module current limit of the module current limits, an average of the module current limits, etc., of the modules contained in the pack (e.g., the lowest or average module current limit multiplied by the number (or count) of the modules). Additional description of the determination of a pack current limit may be found elsewhere in the present document. See, e.g., FIGS. 2-4 and relevant descriptions thereof.

At block 620, the process 600 includes assessing a system performance metric based on the evaluated current limits of the battery packs. This assessment includes determining system performance metrics calibrated with respect to at least one battery pack having a lower current limit than other packs in the system. The system performance metric may be expressed as a system current limit, calculated by multiplying the lowest pack current limit among the online battery packs of the system by the number of online packs of the system. To identify optimal system configuration, the process 600 includes determining system performance metrics calibrated with respect to one or more battery packs at issue—e.g., the one or more packs limiting energy exchange efficiency due to having lower current limit(s). For example, a battery pack at issue is a battery pack with a lower current limit than other battery packs, e.g., the lowest current limit among the battery packs electrically connected so that the system current limit of the battery packs are limited by the current limit of the battery pack at issue. The system performance calibrated with respect to the battery pack at issue includes a first system performance parameter corresponding to a first system configuration and a second performance parameter corresponding to a second system configuration. In the first system configuration, the plurality of battery packs, including the battery pack at issue, of the battery array are connected to the energy exchange cycle. In the second system configuration, the battery pack at issue (e.g., with the lowest current limit among the battery packs that are electrically connected) is disconnected from the energy exchange cycle, while the other battery packs remain connected to the energy exchange cycle. Additional description of the determination of a system performance metric may be found elsewhere in the present document. See, e.g., FIGS. 2-4 and relevant descriptions thereof.

At decision block 630, the process 600 includes determining whether criteria regarding the system performance metrics is satisfied. This criteria evaluates whether the present system configuration (i.e., the present connection status of battery packs) provides better system performance compared to an alternative configuration. If the criteria are not satisfied (No path), indicating the present configuration provides optimal performance, the process returns to block 610 for continued monitoring. If the criteria are satisfied (Yes path), indicating that a change in configuration may improve system performance, the process proceeds to block 640.

For example with reference to an energy exchange cycle on the battery system including battery packs pk_1 through pk_4 electrically connected in parallel as illustrated in FIG. 3 with the operational parameters as noted in Tables 1 and 2, the present system configuration is that all the battery packs are online. As already described, pk_4 is at issue, having the lowest pack current limit among the four battery packs; the system performance metric calibrated with respect to pk_4 includes a first system performance parameter of 240 amperes, corresponding to a first connection configuration (the present system configuration) in which all four battery packs are online, and a second system performance parameter of 300 amperes, corresponding to a second connection configuration (an alternative system configuration) in which pk_4 disconnects from the energy exchange cycle and three battery packs, pk_1 through pk_4, remain online. The calibrated system performance metric including the two system performance parameters indicates that a change in the system configuration by disconnecting pk_4 may improve the system performance (Yes path). The criteria may include additional factors including, e.g., the SOC of the respective battery packs, the power output needs during a discharge cycle, or the like, or a combination thereof. The process 600 may proceed to 640.

As another example at a subsequent time point after pk_4 disconnects from the energy exchange cycle, as charging continues, the current limits of pk_1 through pk_3 may decrease due to their increasing SOCs if the energy exchange cycle is a charge cycle, or their decreasing SOCs if the energy exchange cycle is a discharge cycle. For instance, if the current limits of pk_1 through pk_3 decrease to 80, 75, and 70 amperes, respectively, while the disconnected pk_4's current limit increases to 65 amperes (e.g., due to temperature decrease), the process 600 reassesses system performance. At this time point, the system performance metric calibrated with respect to pk_4 includes a first system performance parameter of 210 amperes (calculated as the lowest current limit among pk_1 through pk_3, which is 70 amperes, multiplied by three, the number (or count) of the packs online) corresponding to the present system configuration with pk_4 disconnected, and a second system performance parameter of 260 amperes (calculated as pk_4's current limit of 65 amperes multiplied by four) corresponding to an alternative configuration with pk_4 reconnected. This comparison indicates that reconnecting pk_4 may improve system performance at this time point (Yes path). In some embodiments, the disconnected pk_4's current limit may remain substantially the same during after being disconnected. Then its current limit at the time of its disconnection may be used in the subsequent reassessments of system performance. The reassessments of the system performance demonstrate the dynamic nature of the process 600 in optimizing system configuration based on evolving operational parameters.

At block 640, the process 600 includes adjusting the connection status of a battery pack at issue (e.g., the battery pack having the lowest current limit among the battery packs of the system). This adjustment may involve disconnecting the battery pack from or reconnecting it to the energy exchange cycle, depending on the present system configuration and which action may improve system performance.

At block 650, the process 600 includes allowing the battery packs that remain online to continue the energy exchange cycle. Following this, the process 600 including looping back to block 610, continuing the evaluation and assessment iteration to ensure ongoing optimal performance of the battery system.

The evaluation and assessment operations may be executed multiple times during the energy exchange cycle, following either a time-based or event-based approach. In a time-based implementation, these operations may be performed at predetermined intervals, which may range from microseconds to minutes. These intervals may be set at various durations such as 100 microseconds, 500 microseconds, 1 second, 5 seconds, 10 seconds, 30 seconds, 1 minute, or other suitable time periods based on system needs or user instruction. In an event-based implementation, the evaluation and assessment may be triggered by specific conditions, such as when a battery pack's SOC exceeds a first threshold value (e.g., the battery pack's SOC being higher than the first threshold value during a charge cycle, the battery pack's SOC being lower than the first threshold value during a discharge cycle), or the rate of SOC change falls below a second threshold value, or when a battery pack's temperature or the rate of temperature change exceeds a defined limit. The timing or triggering of these assessment operations may be configured based on the specific application and operational needs of the battery system.

The flow chart 600 thus represents an iterative process that continuously monitors and optimizes the battery system's performance by dynamically managing the connection status of individual battery packs based on their current limits and the overall system performance metrics.

### INDUSTRIAL APPLICABILITY

The disclosed battery management system and methods may provide advantages in managing multi-pack battery systems across applications such as work machines, electric vehicles, renewable energy storage systems, and industrial equipment.

Some embodiments of the disclosed system may address technical challenges associated with parallel-connected battery packs experiencing varying operational states. Through dynamic assessment and reconfiguration capabilities, the system can improve or optimize overall performance when individual battery packs exhibit different current limits due to variations in state of charge, temperature, or other operational parameters.

The modular architecture of the battery array, combined with the adaptive management approach, may offer multiple technical benefits. The hierarchical control structure—from cell level to module level to pack level to array level—can enable granular monitoring and control while maintaining efficient system-wide management. Each battery pack can operate semi-independently while contributing to the overall system performance, allowing for flexible system scaling and configuration.

The system may maintain higher overall current capability by strategically disconnecting battery packs that may otherwise limit system performance. For example, in scenarios where one battery pack's current limit constrains the system, disconnecting that pack may allow the remaining packs to operate at higher current limits, potentially increasing the total system current capability.

The disclosed system may provide enhanced flexibility in managing battery pack degradation. As battery packs age or experience different usage patterns, their performance characteristics can diverge. The system's ability to dynamically evaluate and adjust pack connections may maintain optimal system performance despite these variations.

The continuous monitoring and assessment features may enable proactive system optimization. The system can identify and implement beneficial configuration changes based on (substantially) real-time operational parameters, supporting consistent power availability in various applications.

The described methods may contribute to extended battery system longevity. By managing current limits and pack connections, the system can prevent stress on individual battery packs. The ability to temporarily disconnect packs experiencing unfavorable conditions while maintaining system operation may preserve battery health.

The modular design may facilitate system maintenance and upgrades. Individual battery packs can be disconnected, serviced, or replaced without shutting down the entire system. This capability can reduce system downtime and enable progressive system updates or capacity expansions.

In industrial settings, the disclosed system can maintain functionality even when individual battery packs need temporary disconnection for thermal management or other operational considerations. The dynamic reconfiguration capability may sustain system availability during various operational conditions.

The system's real-time optimization capabilities may enhance energy efficiency. By ensuring that battery packs operate within their optimal current limits and adjusting system configuration accordingly, the system can increase or maximize energy utilization while maintaining safe operating conditions.

These capabilities may apply to grid storage applications, electric vehicle systems, and other power applications where multiple battery packs operate in parallel. The adaptive nature of the management system can allow for effective utilization of battery resources while reducing system maintenance needs.

The modular architecture and adaptive management approach may also support future system expansion. Additional battery packs can be integrated into the existing array, with the control system automatically incorporating them into its optimization strategies. This scalability may provide flexibility in system design and deployment across various applications.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A battery system, comprising:
a battery array comprising a first battery pack and a second battery pack, each of the first battery pack and the second battery pack comprising at least one battery cell; and
a battery array controller configured to:
for each of multiple time points during an energy exchange cycle,
evaluate current limits of the first and second battery packs; and
assess a system performance metric based on the current limits of the first and second battery packs; and
at a first time point of the multiple time points during the energy exchange cycle:
determine that the current limit of the first battery pack is lower than the current limit of the second battery pack;
determine that the system performance metric calibrated with respect to the first battery pack satisfies a criterion;
command the first battery pack to disconnect from the energy exchange cycle; and
allow the second battery pack to continue the energy exchange cycle based on a current limit higher than the current limit of the first battery pack.

2. The battery system of claim 1, wherein the battery array controller is further configured to, at a second time point of the multiple time points that is subsequent to the first time point:
determine that the system performance metric calibrated with respect to the first battery pack no longer meets the criterion;
command the first battery pack to reconnect to the energy exchange cycle; and
allow both the first and second battery packs to continue the energy exchange cycle.

3. The battery system of claim 2, wherein the battery array controller is further configured to determine that a difference between the current limit of the first battery pack and the current limit of the second battery pack at the second time point is below a threshold.

4. The battery system of claim 1, wherein the battery array controller is configured to dynamically determine the current limit of the first or second battery pack based on at least one operational parameter comprising: temperature, state of charge (SOC), state of health, or internal resistance of the first or second battery pack.

5. The battery system of claim 1, wherein at least one of the first or second battery pack comprises a temperature sensor configured to measure temperature of the first or second battery pack.

6. The battery system of claim 1, wherein the battery array controller is further configured to:
dynamically adjust, during the energy exchange cycle, a connection status of either one of the first or second battery pack based on at least one of a change in the current limit of the first or second battery pack or the system performance metric.

7. The battery system of claim 1, wherein the system performance metric comprises at least one of: total system current capacity, power input or output capability, energy input or output capacity, or thermal management effectiveness.

8. The battery system of claim 1, wherein:
the system performance metric calibrated with respect to the first battery pack comprises a first performance parameter corresponding to a first system configuration and a second performance parameter corresponding to a second system configuration, wherein:
in the first system configuration, the first battery pack is disconnected from the energy exchange cycle and the second battery pack remains connected to the energy exchange cycle; and
in the second system configuration, both the first and second battery packs are connected to the energy exchange cycle; and
the battery array controller is further configured to determine the system performance metric calibrated with respect to the first battery pack by determining the first performance parameter and the second performance parameter.

9. The battery system of claim 8, wherein the criterion comprises that the first performance parameter exceeds the second performance parameter.

10. The battery system of claim 1, wherein the energy exchange cycle is a charge cycle or a discharge cycle.

11. The battery system of claim 1, wherein the battery array controller is configured to allow the second battery pack to continue, at the first time point, the energy exchange cycle at the current limit of the second battery pack corresponding to the first time point.

12. The battery system of claim 1, wherein:
the energy exchange cycle is a charge cycle, and
the battery array controller is further configured to, at the first time point:
estimate an SOC of the first battery pack and an SOC of the second battery pack; and
determine that the SOC of the first battery pack exceeds the SOC of the second battery pack.

13. A work machine, comprising:
an electric motor; and
a battery system configured to power the electric motor, the battery system comprising:
a battery array comprising a plurality of battery packs, each of the plurality of battery packs comprising at least one battery cell; and
a battery array controller configured to:
for each of multiple time points during an energy exchange cycle,
evaluate current limits of the plurality of battery packs; and
assess a system performance metric of the battery system based at least in part on the current limits of the plurality of battery packs; and
at a first time point of the multiple time points during the energy exchange cycle:
determine that the current limit of at least one battery pack is lower than a current limit of each of one or more remaining battery packs of the battery array;
determine that the system performance metric calibrated with respect to the at least one battery pack satisfies a criterion;
command the at least one battery pack to disconnect from the energy exchange cycle; and
allow the one or more remaining battery packs to continue the energy exchange cycle with each of the one or more remaining battery packs operating at a current limit higher than the current limit of the at least one battery pack.

14. The work machine of claim 13, wherein allowing the one or more remaining battery packs to continue the energy exchange cycle comprises:
determining a lowest current limit among the one or more remaining battery packs at the first time point; and
regulating the energy exchange cycle for the one or more remaining battery packs based on the determined lowest current limit.

15. The work machine of claim 13, wherein the energy exchange cycle comprises a charge cycle or a discharge cycle.

16. The work machine of claim 13, wherein assessing the system performance metric of the battery system based on the current limits comprises:
identifying one or more battery packs whose current limits are lower than current limits of other battery packs of the battery array;
determining a first system performance parameter corresponding to a first system configuration and a second performance parameter corresponding to a second system configuration, wherein
in the first system configuration, the identified one or more battery packs are disconnected from the energy exchange cycle and the other battery packs of the battery array remain connected to the energy exchange cycle, and
in the second system configuration, the plurality of battery packs of the battery array are connected to the energy exchange cycle; and
comparing the first system performance parameter and the second system performance parameter.

17. A method for managing a battery system, comprising:
for each of multiple time points during an energy exchange cycle on a battery system that comprises a battery array,
evaluating, by a battery array controller, current limits of a first battery pack and a second battery pack of the battery array, each of the first battery pack and the second battery pack comprising at least one battery cell; and
assessing, by the battery array controller, a system performance metric of the battery system based on the current limits of the first and second battery packs; and
at a first time point of the multiple time points during the energy exchange cycle:
determining, by the battery array controller, that the current limit of the first battery pack is lower than the current limit of the second battery pack;
determining, by the battery array controller, that the system performance metric calibrated with respect to the first battery pack satisfies a criterion;
commanding, by the battery array controller, the first battery pack to disconnect from the energy exchange cycle; and
allowing, by the battery array controller, the second battery pack to continue the energy exchange cycle based on a current limit higher than the current limit of the first battery pack.

18. The method of claim 17, further comprising:
dynamically determining the current limit of the first or second battery pack based on at least one operational parameter comprising:
temperature, state of charge, state of health, or internal resistance of the first or second battery pack.

19. The method of claim 17, further comprising:
dynamically adjusting, during the energy exchange cycle, a connection status of either one of the first or second battery pack based on at least one of a change in its current limit or the system performance metric.

20. The method of claim 17, wherein the system performance metric comprises at least one of: total system current capacity, power input or output capability, energy input or output capacity, or thermal management effectiveness.
